(19) United States
(12) Patent Application Publication
(10) Pub. No.: US 2006/0170951 A1
(43) Pub. Date: Aug. 3, 2006

(54) Method and arrangement for inhibiting counterfeit printing of legal tender

(75) Inventors: Charles Jia, San Diego, CA (US); Laura Zhou, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P.

(21) Appl. No.: 11/045,377

(22) Filed: Jan. 31, 2005

(51) Int. Cl. G06K 15/00

(52) U.S. Cl. 358/1.14

(57) ABSTRACT

A method of inhibiting printing of counterfeit legal tender is such as to analyze acquired digital image data to detect a presence of data indicative of predetermined fibers in an image represented by the image data. This method further includes one of modifying or preventing printing of a image in accordance with an outcome of the analysis of the image data.

### BACKGROUND OF THE INVENTION

1. Field of the Invention

The present invention relates generally to a technique which prevents counterfeit copies of legal tender, such as paper currency and the like, from being produced using copying or printing devices. More specifically, the present invention relates to a technique wherein features, which are used to enable the differentiation of real currency from counterfeit copies, are detected and the image is either modified at the time of printing or prevented from being reproduced completely.

2. Description of the Related Art

Counterfeiting used to be the domain of skilled criminals with expensive engraving and printing equipment. According the U.S. Secret Service, in 1995, less than two percent of counterfeit money in the U.S. was produced electronically. However, of recent times, nearly 40 % of the millions of counterfeit money that has been produced has been produced using digital equipment like color copiers, scanners and ink jet printers.

Efforts have been made to provide scanners with the ability to detect situations wherein it is scanning U.S. banknotes such as a $20 bill (for example). However, despite these advances it is still possible to find a high-quality, printable image of this type of currency on the Internet, or to take a digital photograph of paper currency and produce a high quality digital image that can be used for printing purposes. Accordingly, the technique of providing scanners with the ability to block the printing/reproduction of paper currency has not proven completely successful in preventing counterfeiting using commercially available printers and the like.

Therefore, there is a need to find a way to unobtrusively prevent the reproduction of U.S. banknotes on home equipment without affecting the quality or the print speed of all other print jobs.

### BRIEF DESCRIPTION OF THE DRAWINGS

FIG. 1 is a block diagram which provides an overview of the process implemented by embodiments of the present invention.

FIG. 2 is a flow diagram which illustrates the steps performed in accordance with an embodiment of invention;

FIG. 3 is a flow diagram which illustrates a sub-routine that is run in connection with the fine feature extraction step of the routine depicted in the flow chart of FIG. 2.

FIG. 4 a flow diagram which illustrates a sub-routine that is run in connection with the fine feature analysis step of the routine depicted in the flow chart of FIG. 2.

FIG. 5 is a flow chart depicting a further embodiment of the invention.

FIG. 6 is a schematic diagram of a printer equipped with an embodiment of the invention and showing examples of the avenues via which the image data which is examined in accordance with the invention can be supplied to the printer.

### DETAILED DESCRIPTION OF THE EMBODIMENTS

Efforts in 1998 to counter counterfeit printing resulted in the world's first Counterfeit Deterrence System (CDS). The CDS provides a solution which prevents reproduction of U.S. banknotes via printers without affecting the quality and print speed of regular home printing. The U.S. Bureau of Engraving and Printing adopted the CDS system in their banknote design as a way to deter small scale counterfeiting operations. For example, the new U.S. $20 note issued in October 2003, was the first U.S. bank note to include the secret marking detectable by printers. In the future, a single invisible mark is planned to be used widely throughout the member nations of the Central Bank Counterfeit Deterrence Group (CBCDG) so that printers only have to detect a single mark in each currency. Upon detection of the invisible mark, the printers refuse to print a copy of the bank note and instead print a message such as a URL for a web site which provides information for users about counterfeit laws in their respective nation.

However, in that almost any anti-counterfeiting technology can be circumnavigated, the challenge is to make counterfeiting much more difficult if not impossible or make the reproduction easily identifiable as a fake. Accordingly, an embodiment of the invention is configured such that the counterfeiting inhibition is achieved by detecting the presence of colored fibers that have been deliberately woven into the paper (viz., the medium) on which the U.S. currency is printed. Once these colored fibers are detected, the printing of the image containing the same, is either stopped or modified.

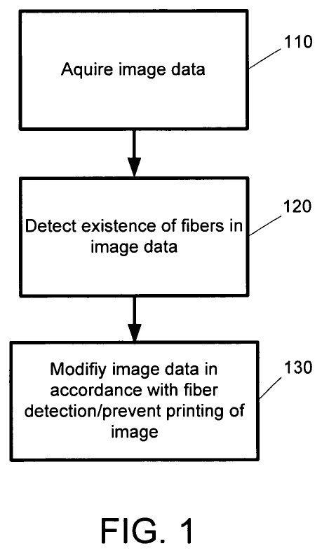

FIG. 1 is an overall depiction (viz., an overview) of the operations which are carried out in connection with the exemplary embodiments of the invention. More specifically, step 110 is such as to acquire the image data. This can be accomplished either by scanning, downloading of image data from a digital camera (for example) or downloading of image data via the internet, or any other suitable technique. Step 120 is such as to examine/analyze the digital data indicative of the image and to determine if the image contains, in this instance, the colored fibers which are found in the paper on which the currency in question is printed. In the event that the fibers are found with a sufficiently high degree of confidence, then the algorithms which are responsible for the examination and analysis, implement a predetermined form of action. This action can, for example, take the form of completely preventing the printing of the image, printing a modified form of the image, printing a warning message concerning the ramifications of counterfeiting, and/or the like.

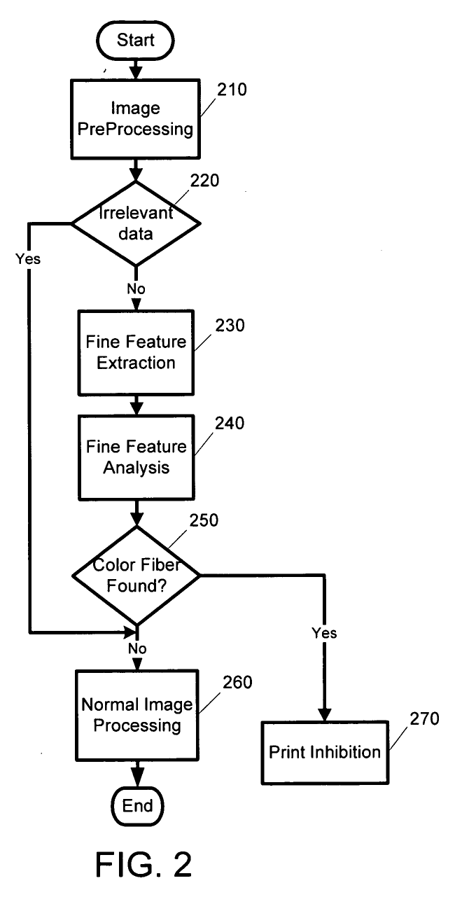

FIG. 2 is a flow chart which depicts the operations which are carried out in accordance with an embodiment of the invention. In this embodiment, a routine is arranged to pre-process the image data (step 210) which has been acquired in a manner such as discussed above in connection with step 110 of FIG. 1. In step 220, it is determined if the image data is capable of containing an image of paper currency or is, for example, data which has been received via facsimile or is black and white or otherwise data which can be immediately determined to be free of an image which is to be used to produce counterfeit currency. In the latter instance the image data can be treated in a conventional manner and printed without further investigation/analysis. That is to say, in the event that it is concluded that the data is irrelevant, that is to say, does not contain any data which might be an image of legal tender then the routine goes immediately to step 260 wherein normal printing of the image is permitted.

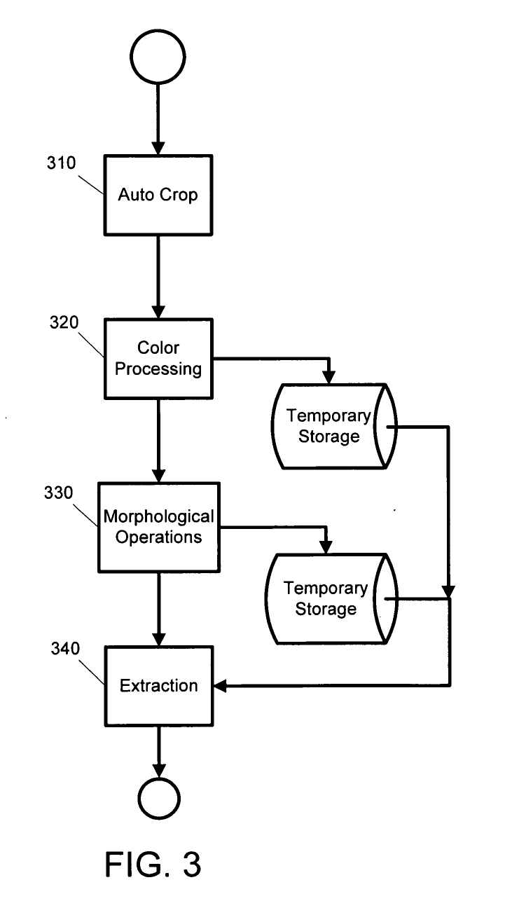

On the other hand, if there is sufficient evidence to suggest that the data contains an image or images of legal tender that someone is attempting to copy (i.e. counterfeit) then the routine proceeds to step 230 wherein a fine feature extraction sub-routine is run. This sub-routine is shown in FIG. 3.

The first step (step 310) of the fine feature extraction sub-routine is such as to auto crop the image. Assuming, in this instance, that the image data has been obtained through the use of a scanner, this step is such as to automatically determine the presence of unwanted extraneous information caused by scanner background information/noise. Once the presence of this information is determined, the sub-routine computes, for instance, skew and crop statistics. From this, the image is automatically deskewed and cropped appropriately without the background and extraneous information. This is accomplished by first determining the presence of unwanted extraneous and background information and then appropriately processing the document image.

The extraneous information is ignored during deskew and crop computations. Also, the scanner background and the extraneous information are prevented from being included with the final digital representation of the image.

This embodiment is, however, not limited to data which is obtained via a scanner and in the event that the image data is obtained though a digital camera or photograph, for example, the above mentioned skew or some other form of distortion may exist which may need to be taken into consideration. A downloaded image from the internet, however, would be expected to be without noise or characteristics that would require correction, nevertheless, all of the image data is, in accordance with this embodiment, subjected to the scrutiny which is included in this step.

This step can also be used to recognize data which represents one or more images of legal tender, for example one or more 20 dollar bills. This data can be stored and held for use later in step 440 for example, which will be discussed in more detail hereinlater.

In addition to the above, this auto crop step 310 can be configured to locate an area of the image which is suitable for further analysis. This is, “spot light” an area (or areas) on the image in which colored printing is absent and which is predominantly if not completely the off-white color of the paper on which the tender is printed. This presents an area where the presence or absence of the fibers which are used to distinguish genuine “spot lighting” is controlled to fall within the boundaries of image data which is suspected to be an image of legal tender. Alternatively, the border area which surrounds the rectangular printed outline of a 20 dollar bill (for example) and be targeted as being a location to crop and inspect for the colored fibers in question.

The next step (step 320) is such as to process the colors which are found in the selected area. In this embodiment, the two colors that are of interest are red and blue. However, it must be appreciated that scanner is apt to “view” the colors in a manner different from that using the naked eye.

Accordingly, it is necessary to mark the locations where colors which are sufficiently close (given the variation that is apt to occur with different types/grades of scanner) to be suspected to be those which are being sought. Following this, the data is separated into two images, one with color and the other in grayscale. The grayscale image is used because it exhibits a level of darkness or luminosity. This image is subjected to morphological analysis in order to find the thin threads or fibers (viz., the fine features in the image).

In step 330, the routine examines a number of parameters such as geometric characteristics. Inasmuch as the search is directed to finding short threads, if a relatively long line is found, such as red lines on the page of a notebook, then this line can be logged as not being a target thread because it is too long and without the curvature which is expected in the threads. One or more well known morphological operations including opening, closing, erosion and dilation, are then used to subject the fine features such as the threads which are being sought, to a process that will in effect remove them from the image data.

By determined what is removed by this type of processing, it is possible in step 340 to determine/extract what parts of the image data define the fine images indicative the threads being sought. These fine features can be further examined to determine if they have characteristics which will enable some to be excluded from consideration. For example, if the feature is the corner of a large stain, for example only, this can be ignored.

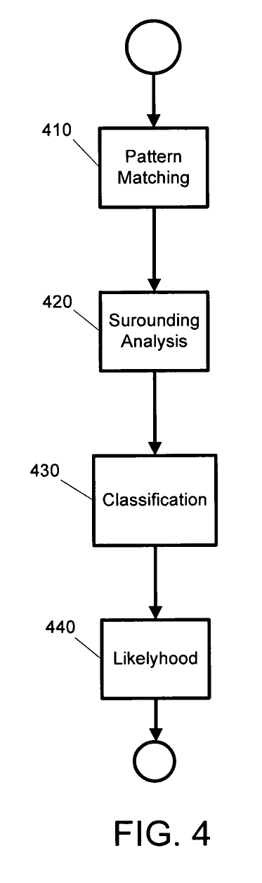

Following this extraction, the routine moves into the subroutine depicted in flow chart form in FIG. 4. As shown, the first step of this sub-routine (step 410) involves pattern matching. It should be noted that, in addition to the collection of suspected lines which have been determined using the grayscale image, the data thus far developed also includes color information. This color information is collected irrespective of the fact that it may be vague at some points due to the scanners inherent inability to see colors exactly the same way as the human eye perceives them, and because the fibers blend in with the paper, there might be other colors which need to be included in the examination. For example, because the fibers tend to not reflect light in the same manner as other materials. Nevertheless, the color information is used with that obtained above in the extraction step 340.

In the pattern matching step 410, the input data of the fine lines, line fragments etc., (viz., all the fine features) is used. It should be noted that this is not matching with a prescribed pattern, but rather a determination what part of the fine features that have been collected meet the criteria that used to define the fibers which are being sought. In this step, it is possible to again determine if the lines are too long to be considered to be fibers and/or if they are so straight as to lack the required curvature. In addition, now that the color of the lines has been added, a further test is whether the lines change color along their length or if they exhibit the necessary continuous tone.

While the above color change is a security feature in the bills it is not something that is being sought in connection with the fibers which are being searched for. In other words, there might be data wherein a line that changes color. Lets say red, to green, to blue, for example. If such lines are found, the sub routines determines that these are not the fibers being sought and ignores them.

In step 420, a surrounding analysis is applied. This surrounding analysis is basically a determination if there is any real data in the area. Frequently, when an image is scanned, there is a piece of like hair or lint, for example, on the glass. This produces noise. Accordingly, in step 430 each line is labeled or classified in accordance with what each is suspected to be.

Next, in step 440, the likelihood of the target fibers being located in the image is determined. This determination is not just based on finding data which corresponds with the target fibers, that is to say color, curvature, length, but also the distribution of the target fibers. If the number of fibers is abnormally higher or lower than the expected value, then the likelihood of a counterfeiting effort is lowered. This also applies to the color distribution. An abnormal amount of one color verses the other can also be used to set the likelihood value lower than if an expected red/blue number of threads are found per unit area.

Step 440 can also use the results from other examinations of the data to confirm/modify that the image data contains data which is indicative of the fact that someone is attempting to counterfeit legal tender. These test can include detection of micro printing color shifting ink printing in the bank note, security thread, the federal reserve indicator, and/or concentric fine lines. For example, if there are five separate tests (including an embodiment of the invention) to determine if the image data contains an image of legal tender which can be assumed to be part of a process to illegally reproduce the currency image or images (i.e. an attempt to produced counterfeit money) and the results of a given percentage of these test suggest that this in fact the situation, then the likelihood factor/value can be modified (increased or decreased) in an appropriate manner.

At step 250, the likelihood value is screened against a predetermined value or standard and if its exceeds the predetermined value, the routine will flow to step 270 whereat an appropriate printing inhibition is enforced. As noted above, this can be a complete blockage of printing or can be result in the colors and/or the image being modified to the point of being totally different from the original and such that the resulting printout will be readily recognizable as not being legal tender. Of course it is possible to print out a warning or advice document in place of the scanned image.

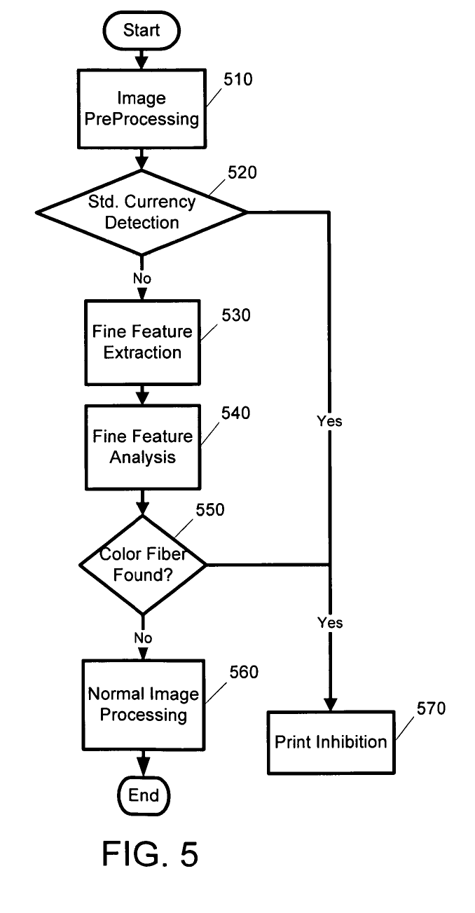

FIG. 5 shows another embodiment of the invention. In this embodiment the image data which is preprocessed in step 510 is such as to apply standard currency detection processes to screen the data for images of legal tender. If these processes ascertain with a high degree of certainty that the image data contains data indicative of images of legal tender, and that the there is a high degree of certainty that someone is attempting to counterfeit the legal tender, then the routine immediately goes to step 570 wherein a print inhibition of the nature discussed in connection with step 270 is put into effect.

However, should the detection of legal tender not be made with a sufficiently high degree of confidence to inhibit printing, the routing flows to steps 530, 540 and 550. These steps can, in this embodiment, be the same as steps 230, 240 and 250 discussed above.

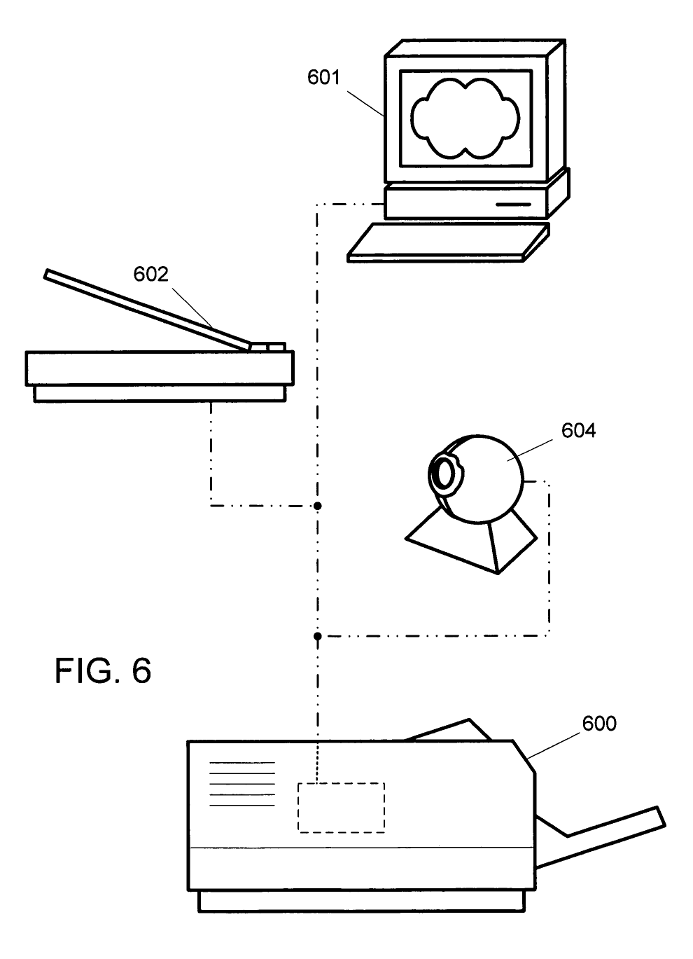

FIG. 6 shows a printer 600 which is equipped with an embodiment of the invention. As shown this printer is arranged to receive data either from a web server 601, a scanner 602 or a digital camera 604. It should be noted that these latter mentioned elements are shown schematically and should not be taken to accurately depict the structures/arrangements they represent. A personal computer (PC) not shown, could be used to interface with the web server 601, scanner 602 and the digital camera 604.

Although the invention has been described with reference to only a limited number of embodiments it will be understood that a person or skill in the art to which the invention pertains or mostly closely pertains, would, given the proceeding disclosure, be able to envisage various variations/embodiments without departing from the scope of the invention which is limited only by the appended claims.

What is claimed is:

1. A method of inhibiting counterfeit printing of legal tender comprising:
analyzing acquired digital image data to detect a presence of data indicative of predetermined fibers in an image represented by the image data; and
at least one of modifying and preventing printing of a image in accordance with an outcome of the analysis of the image data.

2. A method as set forth in claim 1, wherein the acquired image data comprises image data indicative, at least in part, of an image of the legal tender.

3. A method as set forth in claim 1, wherein the image data is acquired by scanning the legal tender with a scanner.

4. A method as set forth in claim 1, wherein the image data of the legal tender is acquired by download.

5. A method as set forth in claim 4, wherein the download is acquired from a digital photograph of the legal tender.

6. A method as set forth in claim 4, wherein the download is acquired from the internet.

7. A method as set forth in claim 1, wherein the analyzing of the acquired image data comprises cropping a portion of the image data to facilitate analysis of a remaining portion of the image data for predetermined characteristics.

8. A method as set forth in claim 7, comprising executing morphological operations on the remaining portion of the image data which are configured to locate fine image features.

9. A method as set forth in claim 8, wherein the morphological operations comprise at least one of erosion, dilation, opening and closing.

10. A method as set forth in claim 7, wherein the step of analyzing the acquired image data comprises identifying at least one of fine features, objects, and boundaries within the image data.

11. A method as set forth in claim 1, wherein the step of modifying the printing of the image comprises preventing the image data from printing as an output document containing an accurate image of the legal tender.

12. A method as set forth in claim 1, wherein the step of modifying the printing of the image step comprises recognizably changing the color of the image represented by the image data.

13. A method as set forth in claim 1, wherein the fibers comprise red and blue fibers that are woven into paper on which the legal tender is printed.

14. A system for inhibiting printing of counterfeit legal tender comprising: a circuit which analyzes acquired digital image data to detect a presence of data indicative of predetermined fibers in an image represented by the image data; and which at least one of modifies and prevents printing of a image in accordance with an outcome of the analysis of the image data.

15. A system as set forth in claim 14, wherein the circuit is disposed in a printer.

16. A system as set forth in claim 14, wherein the acquired image data comprises image data which is, at least in part, of indicative of legal tender to be reproduced by a printer.

17. A system as set forth in claim 14, wherein the image data is acquired by scanning the legal tender with a scanner.

18. A system as set forth in claim 14, wherein the image data of the legal tender is acquired by download.

19. A system as set forth in claim 18, wherein the download is acquired from a digital photo of the legal tender.

20. A system as set forth in claim 18, wherein the download is acquired from the internet.

21. A system as set forth in claim 14, wherein the analyzing of the acquired data comprises cropping a portion of the image data to facilitate analysis of a remaining portion of the image data for predetermined characteristics.

22. A system as set forth in claim 21, comprising executing morphological operations on the remaining portion of the image data which are configured to locate fine image features.

23. A system as set forth in claim 22, wherein the morphological operations comprise at least one of erosion, dilation opening and closing.

24. A system as set forth in claim 14, wherein the step of analyzing the acquired digital data comprises identifying at least one of fine features, objects, and boundaries within the image data.

25. A system as set forth in claim 14, wherein the step of modifying the printing reproduction of the image comprises preventing the image from printing as an output document containing an accurate image of the legal tender

26. A system as set forth in claim 14, wherein the step of modifying the printing reproduction of the image step comprises recognizably changing the color of the image represented by the image data.

27. A system as set forth in claim 14, wherein the fibers comprise red and blue fibers that are woven into paper on which legal tender is printed.

28. A counterfeit inhibiting program product comprising machine readable program which when executed causes a printer to:
analyzing acquired digital image data to detect a presence of data indicative of predetermined fibers in an image represented by the image data; and
one of modify and preventing printing of a image in accordance with an outcome of the analysis of the image data.

29. A counterfeit inhibiting program product as set forth in claim 28, wherein the acquired image data comprises image data which, at least in part, is indicative of the legal tender.

30. A counterfeit inhibiting program product as set forth in claim 28, wherein the image data of the legal tender is acquired by scanning legal tender with a scanner.

31. A counterfeit inhibiting program product as set forth in claim 28, wherein the digital data of the legal tender is acquired by download.

32. A counterfeit inhibiting program product as set forth in claim 31, wherein the download is acquired from a digital photograph of the legal tender.

33. A counterfeit inhibiting program product as set forth in claim 31, wherein the download is acquired from the internet.

34. A counterfeit inhibiting program product as set forth in claim 28, wherein the analyzing of the acquired digital data comprises cropping a portion of the image data to facilitate analysis of a remaining portion of the image data for predetermined characteristics.

35. A counterfeit inhibiting program product as set forth in claim 28, wherein the analyzing of the acquired digital data comprises executing morphological operations on the remaining portion of the image data which are configured to locate fine features.

36. A counterfeit inhibiting program product as set forth in claim 35, wherein the morphological operations comprise at least one of erosion, dilation, opening and closing.

37. A counterfeit inhibiting program product as set forth in claim 28, wherein the step of analyzing the acquired digital data comprises identifying fine features, objects, and boundaries within the scanned image.

38. A counterfeit inhibiting program product as set forth in claim 28, wherein the step of modifying the printing reproduction of the image comprises preventing the image from printing as an accurate image of the legal tender.

39. A counterfeit inhibiting program product as set forth in claim 28, wherein the step of modifying the printing reproduction of the image step comprises recognizably changing the color of the image represented by the image data.

40. A counterfeit inhibiting program product as set forth in claim 28, wherein the fibers comprise red and blue fibers that are woven into paper on which legal tender is printed.

41. A printer arrangement for inhibiting printing of counterfeit legal tender comprising:
means for analyzing acquired digital image data to detect a presence of data indicative of predetermined fibers in an image represented by the image data; and
means for at least one of modifying and preventing printing of a image in accordance with an outcome of the analysis of the image data.

42. A printer arrangement as set forth in claim 41, wherein the acquired image data comprises image data indicative, at least in part of an image of legal tender to be reproduced by a printer.

43. A printer arrangement as set forth in claim 41, wherein the image data is acquired by scanning with a scanner.

44. A printer arrangement as set forth in claim 41, wherein the data is acquired by download.

45. A printer arrangement as set forth in claim 44, the download is acquired from a digital photograph of the legal tender.

46. A printer arrangement as set forth in claim 43, wherein the download is acquired from the internet.

47. A printer arrangement as set forth in claim 41, wherein the analyzing of the acquired image data comprises cropping a portion of the image data to facilitate analysis of a remaining portion of the image data for predetermined image characteristics.

48. A printer arrangement as set forth in claim 47, comprising executing morphological operations on the remaining portion of the image data which are configured to locate fine image features.

49. A printer arrangement as set forth in claim 48, wherein the morphological operations comprise at least one of erosion, dilation, opening and closing.

50. A printer arrangement as set forth in claim 41, wherein the step of analyzing the acquired digital data comprises identifying at least one of fine features, objects, and boundaries within the image data.

51. A printer arrangement as set forth in claim 41, wherein the step of modifying the printing of the image comprises preventing the image data from reproducing as an output document containing an accurate image of the legal tender.

52. A printer arrangement as set forth in 41, wherein the step of modifying the printing of the image data comprises recognizably changing the color of the image represented by the image data.

53. A printer arrangement as set forth in claim 41, wherein the fibers comprise red and blue fibers that are woven into paper on which legal tender is printed.

54. A program product for inhibiting a printer from printing counterfeit legal tender comprising:
a computer usable medium having a computer readable program code embodied therein to be executed in a printer, the computer readable program code comprising:
computer code for analyzing acquired digital image data to detect a presence of data indicative of predetermined fibers in an image represented by the image data; and
computer code for at least one of modifying and preventing printing of a image in accordance with an outcome of the analysis of the image data.

55. A program product as set forth in claim 54, wherein the acquired image data comprises image data indicative, at least in part, of an image of the legal tender.

56. A program product as set forth in claim 54, wherein the image data is acquired by scanning the legal tender with a scanner.

57. A program product as set forth in claim 54, wherein the image data of the legal tender is acquired by download.

58. A program product as set forth in claim 54, the download is acquired from a digital photograph of the legal tender.

59. A program product as set forth in claim 54, wherein the download is acquired from the internet.

60. A program product as set forth in claim 54, wherein the computer code for analyzing of the acquired image data comprises computer code for cropping a portion of the image data to facilitate analysis of a remaining portion of the image data for predetermined characteristics.

61. A program product as set forth in claim 60, further comprising computer code for executing morphological operations on the remaining portion of the image data which are configured to locate fine image features.

62. A program product as set forth in claim 61, wherein the morphological operations comprise at least one of erosion, dilation, opening and closing.

63. A program product as set forth in claim 61, wherein the computer code for analyzing the acquired image data comprises computer code for identifying at least one of fine features, objects, and boundaries within the image data.

64. A program product as set forth in claim 54, wherein the computer code for modifying the printing of the image comprises computer code for preventing the image data from printing as an output document containing an accurate image of the legal tender.

65. A program product as set forth in claim 54, wherein the computer code for modifying the printing of the image step comprises computer code for recognizably changing the color of the image represented by the image data.

66. A program product as set forth in claim 54, wherein the fibers comprise red and blue fibers that are woven into paper on which the legal tender is printed.
